(19) United States
(12) Patent Application Publication
(10) Pub. No.: US 2007/0277094 A1
(43) Pub. Date: Nov. 29, 2007

(54) Method And Apparatus For Transmitting And Receiving Information

(76) Inventor: Andrei Majidian, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/590,519

(22) PCT Filed: Feb. 23, 2005
(86) PCT No.: PCT/GB05/00673

§ 371 Date: Aug. 24, 2006

(30) Foreign Application Priority Data
Feb. 26, 2004 (GB) 0404292.5

(51) Int. Cl. G06F 17/22

(52) U.S. Cl. 715/513

(57) ABSTRACT

A method of transmitting information between first and second electronic devices. The method includes generating (S100) a validator file operable to validate or to not validate eXtensible Markup Language, XML, files according to their structure, transmitting to the second device the validator file itself or information to enable the validator file to be acquired by the second device, generating (S10) an XML file which contains the information to be transmitted structured in such a way that it is validatable (S20) by the generated validator file, transmitting (S30) the XML file to the second device and validating (S40) the XML file received by the second device, wherein the validator file is generated by: acquiring and parsing an example XML file, the XML file having a structure which the validator file to be generated should cause to be validated, to generate a tree structured file comprising a root node and one or more subsidiary nodes each of which corresponds to an element within the example XML file and has an associated child and attribute list which contain the names of zero or more children nodes and zero or more attributes respectively; acquiring and parsing any additional example XML files to generate corresponding additional tree structured files; traversing the or each tree structured file to generate an intermediate structure comprising groups of nodes in which, each time a node is encountered which does not have the same name as any previously encountered node, a new group is created in the intermediate structure and one or more details of the node in question are stored in the group, and each time a node is encountered which does have the same name as any previously encountered node its child and attribute lists are compared with those of the or each previously encountered node having the same name and if there is a match, no further entry is made in the group, but if there is a mismatch, then a new entry comprising one or more details of the node is made within the same group as the previously encountered node of the same name; and generating the validator file based upon the intermediate structure.

### FIELD OF THE INVENTION

The present invention relates to a method and apparatus for transmitting information between electronic devices, especially computers. In particular, the method relates to the use of XML files to enable information to be transmitted between computers to be structured in a well-defined format such that the information may be unambiguously received by a receiving computer and subsequently processed in a reliable manner, and to a method of generating validating files in the form of XML-schema and/or DTD files which enable multiple XML files to be validated to ensure that information to be received by a receiving device can be received from multiple separate devices using different protocols generating and transmitting XML files. Furthermore, the present invention also particularly relates to a method and apparatus for enabling a party to communicate with a plurality of different parties in which different sets of data need to be communicated with different ones of the parties, to enable electronic representations of the different sets of data to be made in such a way that they will be readily processable by all of the parties involved.

### BACKGROUND TO THE INVENTION

In order to assist computers in transferring information between one another in a reliable manner, it has recently been proposed that a computer language known as extensible Mark-up Language (XML) should be used to generate text files structured in a well-defined manner which enables information contained in the files to be reliably extracted by a receiving computer. As is well known in the art, XML is fully declarative, by which it is meant that the significance of many so-called “tags” used in XML files may be user defined. For a discussion of XML see any one of numerous published books on the subject such as “XML for Dummies” by Maria H. Aviram published by IDG Books Worldwide Inc., or see the Internet web-site of the World Wide Web Consortium for information about XML.

Because XML is declarative, XML may be considered as being a “meta-language” which can be used to define individual markup languages which can then be used to generate well structured documents. In order to determine if a particular document is well-structured (i.e. that it complies with the rules of a particular mark-up language) it may be compared with (or “validated” by) either an XML-schema or a Document Type Definition (DTD) file.

Generally speaking, in order to generate XML documents for easy transfer of information between computers, a user generates a DTD or XML-schema file first and then writes subsequent XML files which conform to the “rules” specified in the XML-schema or DTD file. However, in some circumstances, it may be more convenient to write one or more example XML files first and then to generate automatically a suitable XML-schema or DTD file which is appropriate for the or each example XML file.

A number of applications have been developed which provide this functionality. For example, Microsoft Corp. has written a utility which permits an XML-schema to be inferred from an example XML file and also for an XML-schema to be modified to account for a single additional example XML-schema. The utility is referred to as the XSD Inference Utility. Note that in order to use the utility a user would have to write and compile his own specialised code (using the same programming language as that in which the utility has been written). Furthermore, the methodology adopted in this utility results in the utility having a number of drawbacks. In particular, the utility tends to produce unnecessarily long and complicated XML-schema. Additionally, only a single XML file may be processed at any one time by the unmodified utility.

### SUMMARY OF THE INVENTION

According to a first aspect of the present invention, there is provided a method of transmitting information between first and second electronic devices, the method including generating a validator file operable to validate or to not validate extensible Markup Language, XML, files according to their structure, transmitting to the second device the validator file itself or information to enable the validator file to be acquired by the second device, generating an XML file which contains the information to be transmitted structured in such a way that it is validatable by the generated validator, transmitting the XML file to the second device and validating the XML file received by the second device, characterised in that the validator file is generated by:
acquiring and parsing an example XML file, the XML file having a structure which the validator file to be generated should cause to be validated, to generate a tree structured file comprising a root node and one or more subsidiary nodes each of which corresponds to an element within the example XML file;
acquiring and parsing any additional example XML files to generate corresponding additional tree structured files;
traversing the or each tree structured file to generate an intermediate structure comprising a list of lists of elements and sub-elements in which, preferably, each time a node is encountered which does not have the same name as any previously encountered node, a new list is created in the intermediate structure referencing the node in question, and each time a node is encountered which does have the same name as any previously encountered node, its child and attribute lists are compared with those of the or each previously encountered node having the same name and if there is a match, no reference is made to the newly encountered node, but if there is a mismatch, then a new reference is made within the same list as the previously encountered node of the same name; and
generating the validator file based upon the intermediate structure.

Preferably the validator file is either a Document Type Definition, DTD, file or an XML-schema definition file (also known as simply an XML-schema file).

Preferably the method further includes automatically processing the XML file received by the second device in order, for example, to update information stored in a database connected to the second device.

According to a second aspect of the present invention, there is provided a method of generating a validator file operable to validate or to not validate eXtensible Markup Language, XML, files according to their structure, characterised in that the validator file is generated by:
acquiring and parsing an example XML file, the XML file having a structure which the validator file to be generated should cause to be validated, to generate a tree structured file comprising a root node and one or more subsidiary nodes each of which corresponds to an element within the example XML file;
acquiring and parsing any additional example XML files to generate corresponding additional tree structured files;
traversing the or each tree structured file to generate an intermediate structure comprising a list of lists of elements and sub-elements in which, preferably, each time a node is encountered which does not have the same name as any previously encountered node, a new list is created in the intermediate structure referencing the node in question, and each time a node is encountered which does have the same name as any previously encountered node, its child and attribute lists are compared with those of the or each previously encountered node having the same name and if there is a match, no reference is made to the newly encountered node, but if there is a mismatch, then a new reference is made within the same list as the previously encountered node of the same name; and
generating the validator file based upon the intermediate structure.

According to a third aspect of the present invention, there is provided a method of communicating information between two or more parties each controlling a respective device within a distributed environment, the method comprising each device receiving example XML files from each other device with which it is to share information representative of the data which each other party intends to send to the respective device and utilising these, in combination with one or more XML files representative of the data which the party controlling the respective device intends to send to the other devices, generating a validator file which is operable to validate all of the utilised XML files, and using the validator files to validate any received or transmitted XML files communicated between the devices.

Most preferably, the method involves communicating information between three or more devices within a distributed environment, in which not all parties will wish to communicate with all other parties in the distributed environment, such that different parties will wish to communicate with different sets of other parties.

The present invention also provides computer programs and devices for carrying out the above described methods.

The computer programs of the present invention have been written in the Java programming language and reference is occasionally made Java objects, methods etc. However, it is intended that this term should also cover corresponding programming constructs in alternative programming languages such as C++, C#, etc.

### BRIEF DESCRIPTION OF THE FIGURES

In order that the present invention may be better understood, embodiments thereof will now be described, by way of example only, with reference to the accompanying drawings in which:

FIG. 1 is an illustration of a general purpose computer system which may form the operating environment of embodiments of the present invention;

FIG. 2 is a system block diagram of the general purpose computer system of FIG. 1;

FIG. 3 is a flow diagram illustrating the principle steps of a method according to a preferred embodiment of the present invention;

FIG. 4 is a flow diagram of the steps of the ‘generate DTD file’ subroutine of the flow chart of FIG. 3;

FIG. 5 is a schematic diagram of the structure of a typical Intermediate Structure generated in the subroutine of FIG. 4;

FIG. 6 is a schematic diagram of the structure of an example DOM tree generated in the subroutine of FIG. 4;

FIG. 7 is a schematic diagram of the structure of an example DOM tree similar to that of FIG. 6, but showing extra empty text which needs to be pruned;

FIG. 8 is a schematic diagram illustrating how a single DTD file generated according to the subroutine of FIG. 4 can be used to validate a plurality of different individual XML files;

FIG. 9 is a schematic diagram of the structure of an Intermediate Structure similar to that of FIG. 5 but showing more detail;

FIG. 10a is a schematic diagram of a pruned DOM tree generated from a first simple example XML file;

FIG. 10b is a schematic diagram of a pruned DOM tree generated from a second simple example XML file;

FIG. 10c is a schematic diagram of the structure of the Intermediate Structure generated from the DOM trees of FIGS. 10a and 10b; and

FIG. 11 is a schematic diagram of a system of devices communicating with one another according to an embodiment of the present invention.

### DETAILED DESCRIPTION OF A FIRST EMBODIMENT

A first embodiment of the present invention which enables complex information to be unambiguously communicated between connected devices will now be described.

Description of the User Terminal

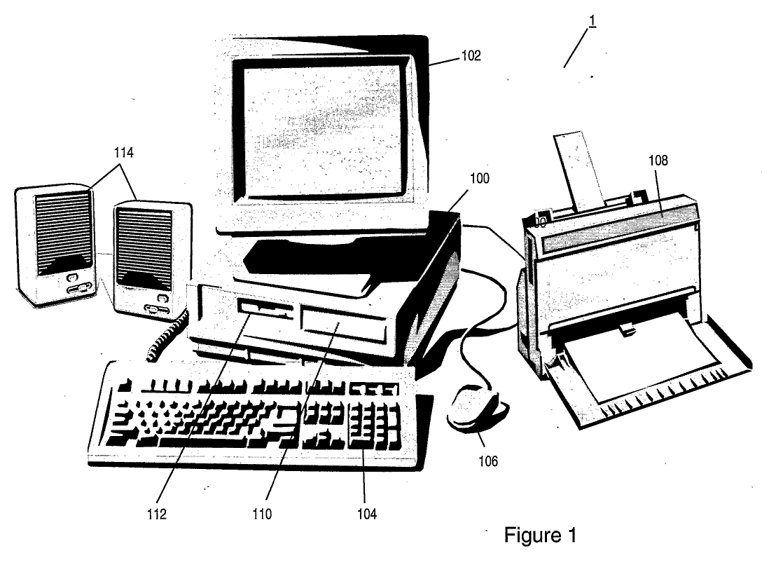

In the first embodiment, an application program, which is key to the correct operation of the method of the first embodiment, is implemented on a general purpose computer system such as that illustrated in FIG. 1 and described in greater detail below. Some of the data used by the application program, together with other computer programs operating to process (or pre-process) that data may be stored on other computer devices, especially computer servers and databases connected to the general computer system of FIG. 1 via a computer network. As with the general computer system of FIG. 1, such devices are well known in the art and are in essence very similar to the computer system illustrated in FIG. 1 with different emphases (e.g. a computer server is unlikely to contain a graphics card or a sound card but is likely to contain multiple Central Processor Unit (CPU) processors, etc.).

FIG. 1 illustrates a general purpose computer system which provides the operating environment of aspects of the embodiments of the present invention. Later, the operation of the invention will be described in the general context of computer executable instructions, such as program modules, being executed by a computer. Such program modules may include processes, programs, objects, components, data structures, data variables, or the like that perform tasks or implement particular abstract data types. Moreover, it should be understood by the intended reader that the invention may be embodied within other computer systems other than those shown in FIG. 1, and in particular hand held devices, notebook computers, main frame computers, mini computers, multi processor systems, distributed systems, etc. Within a distributed computing environment, multiple computer systems may be connected to a communications network and individual program modules of the invention may be distributed amongst the computer systems.

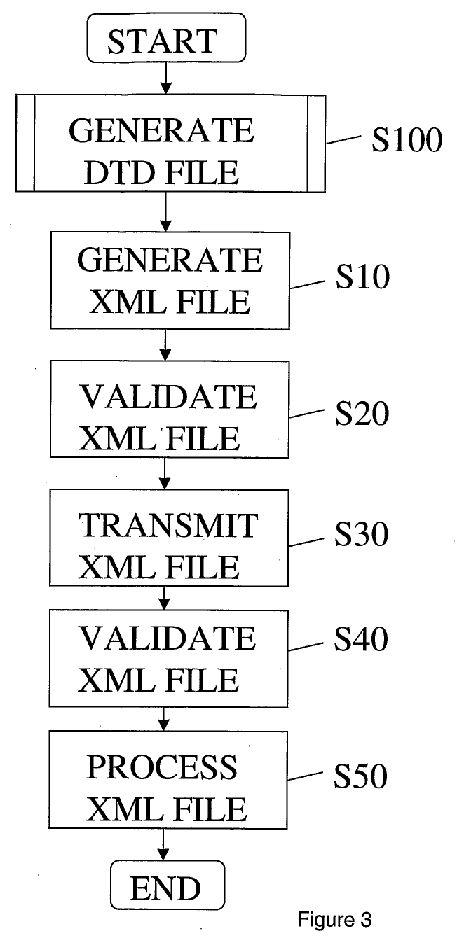

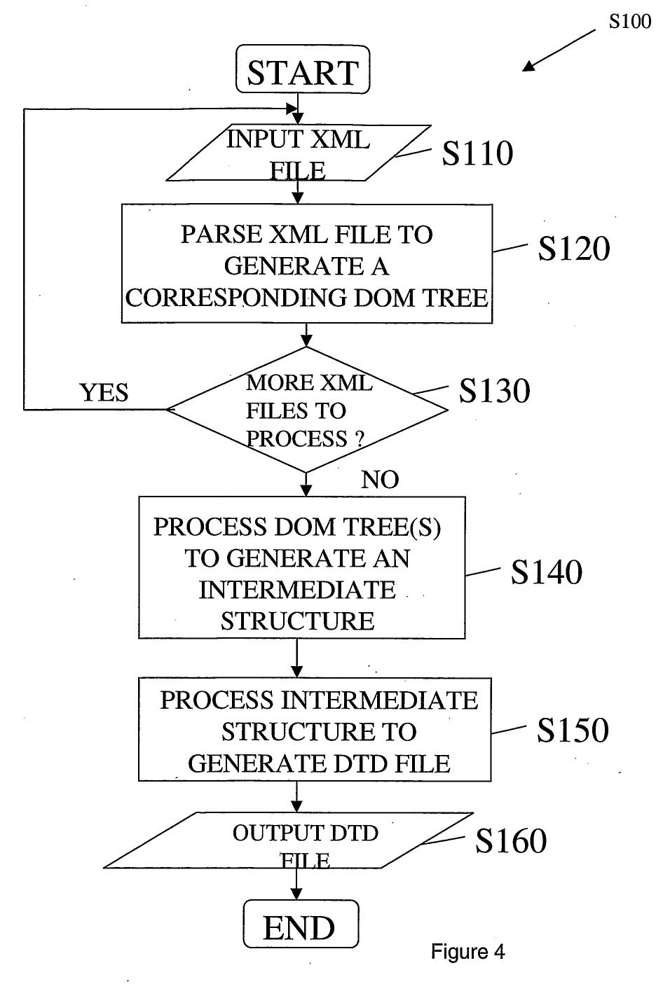

With specific reference to FIG. 1, a general purpose computer system 1 which forms the operating environment of the embodiments of the invention, and which is generally known in the art, comprises a desk-top chassis base unit 100 within which is contained the computer power unit, mother board, hard disk drive or drives, system memory, graphics and sound cards, as well as various input and output interfaces. Furthermore, the chassis also provides a housing for an optical disk drive 110 which is capable of reading from and/or writing to a removable optical disk such as a CD, CDR, CDRW, DVD, or the like. Furthermore, the chassis unit 100 also houses a magnetic floppy disk drive 112 capable of accepting and reading from and/or writing to magnetic floppy disks. The base chassis unit 100 also has provided on the back thereof numerous input and output ports for peripherals such as a monitor 102 having a display screen 3 (see FIGS. 3 and 4) used to provide a visual display to the user, a printer 108 which may be used to provide paper copies of computer output, and speakers 114 for producing an audio output. A user may input data and commands to the computer system via a keyboard 104, or a pointing device such as the mouse 106.

It will be appreciated that FIG. 1 illustrates an exemplary embodiment only, and that other configurations of computer systems are possible which can be used with the present invention. In particular, the base chassis unit 100 may be in a tower configuration, or alternatively the computer system 1 may be portable in that it is embodied in a lap-top or note-book configuration. Other configurations such as personal digital assistants or even mobile phones may also be possible.

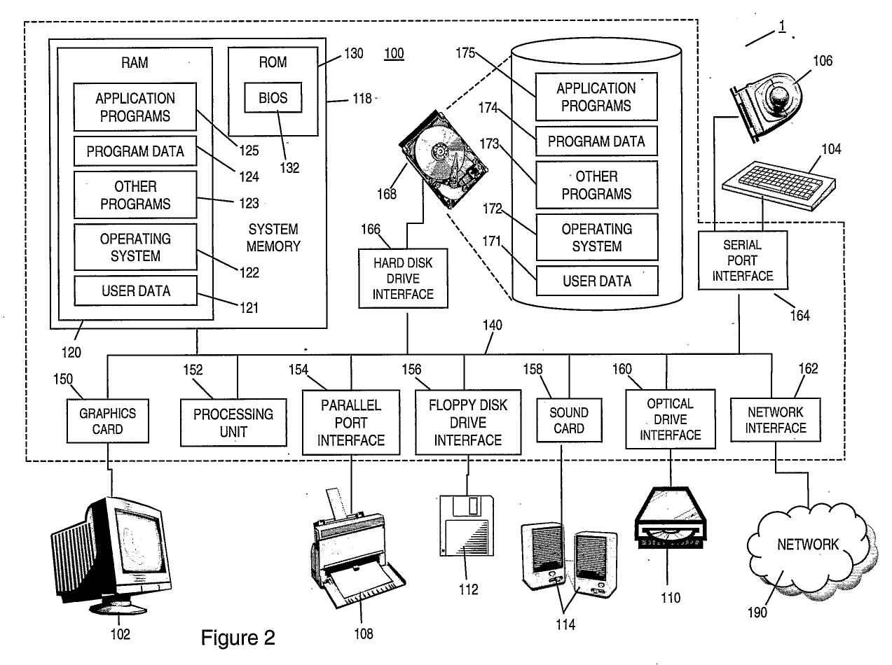

FIG. 2 illustrates a system block diagram of the system components of the computer system 1. Those system components located within the dotted lines are those which would normally be found within the chassis unit 100.

With reference to FIG. 2, the internal components of the computer system 1 include a mother board upon which is mounted system memory 118 which itself comprises random access memory 120, and read only memory 130. In addition, a system bus 140 is provided which couples various system components including the system memory 118 with a processing unit 152. Also coupled to the system bus 140 are a graphics card 150 for providing a video output to the monitor 102; a parallel port interface 154 which provides an input and output interface to the system and in this embodiment provides a control output to the printer 108; and a floppy disk drive interface 156 which controls the floppy disk drive 112 so as to read data from any floppy disk inserted therein, or to write data thereto. In addition, also coupled to the system bus 140 are a sound card 158 which provides an audio output signal to the speakers 114; an optical drive interface 160 which controls the optical disk drive 110 so as to read data from and write data to a removable optical disk inserted therein; and a serial port interface 164, which, similar to the parallel port interface 154, provides an input and output interface to and from the system. In this case, the serial port interface provides an input port for the keyboard 104, and the pointing device 106, which may be a track ball, mouse, or the like.

Additionally coupled to the system bus 140 is a network interface 162 in the form of a network card or the like arranged to allow the computer system 1 to communicate with other computer systems over a network 190. The network 190 may be a local area network, wide area network, local wireless network, or the like. In particular, IEEE 802.11 wireless LAN networks may be of particular use to allow for mobility of the computer system. The network interface 162 allows the computer system 1 to form logical connections over the network 190 with other computer systems such as servers, routers, or peer-level computers, for the exchange of programs or data.

In addition, there is also provided a hard disk drive interface 166 which is coupled to the system bus 140, and which controls the reading from and writing to of data or programs from or to a hard disk drive 168. All of the hard disk drive 168, optical disks used with the optical drive 110, and floppy disks used with the floppy disk 112 provide non-volatile storage of computer readable instructions, data structures, program modules, and other data for the computer system 1. Although these three specific types of computer readable storage media have been described here, it will be understood by the intended reader that other types of computer readable media which can store data may be used, and in particular magnetic cassettes, flash memory cards, tape storage drives, digital versatile disks, or the like.

Each of the computer readable storage media such as the hard disk drive 168, or any floppy disks or optical disks, may store a variety of programs, program modules, or data. In particular, the hard disk drive 168 in the embodiment particularly stores a number of application programs 175, application program data 174, other programs required by the computer system 1 or the user 173, a computer system operating system 172 such as Microsoft® Windows®, Linux™, Unix™, or the like, as well as user data in the form of files, data structures, or other data 171. The hard disk drive 168 provides non volatile storage of the aforementioned programs and data such that the programs and data can be permanently stored without power.

In order for the computer system 1 to make use of the application programs or data stored on the hard disk drive 168, or other computer readable storage media, the system memory 118 provides the random access memory 120, which provides memory storage for the application programs, program data, other programs, operating systems, and user data, when required by the computer system 1. When these programs and data are loaded in the random access memory 120, a specific portion of the memory 125 will hold the application programs, another portion 124 may hold the program data, a third portion 123 the other programs, a fourth portion 122 the operating system, and a fifth portion 121 may hold the user data. It will be understood by the intended reader that the various programs and data may be moved in and out of the random access memory 120 by the computer system as required. More particularly, where a program or data is not being used by the computer system, then it is likely that it will not be stored in the random access memory 120, but instead will be returned to non-volatile storage on the hard disk 168.

The system memory 118 also provides read only memory 130, which provides memory storage for the basic input and output system (BIOS) containing the basic information and commands to transfer information between the system elements within the computer system 1. The BIOS is essential at system start-up, in order to provide basic information as to how the various system elements communicate with each other and allow for the system to boot-up.

Whilst FIG. 2 illustrates one embodiment of the invention, it will be understood by the skilled man that other peripheral devices may be attached to the computer system, such as, for example, microphones, joysticks, game pads, scanners, digital cameras, or the like. In addition, with respect to the network interface 162, we have previously described how this is preferably a wireless LAN network card, although equally it should also be understood that the computer system 1 may be provided with a modem attached to either of the serial port interface 164 or the parallel port interface 154, and which is arranged to form logical connections from the computer system 1 to other computers via the public switched telephone network (PSTN).

Where the computer system 1 is used in a network environment, as in the present embodiment, it should further be understood that the application programs, other programs, and other data which may be stored locally in the computer system may also be stored, either alternatively or additionally, on remote computers, and accessed by the computer system 1 by logical connections formed over the network 190.

Transmitting Information

Referring now to FIG. 3, in order to transmit information unambiguously between two or more computers across a computer network in such a manner that the transmitted information can be successfully processed in a consistent manner by receiving devices using XML according to the present embodiment, the following steps are performed.

At subroutine S100, a DTD file is generated. This defines the structure which XML files wishing to adhere to the DTD file must have and greatly facilitates automatic processing of the information contained in such XML files. The manner in which such DTD files are generated in the present embodiment is described in greater detail below. It is important to note that, for the information to be successfully transmitted, the receiving computer must be aware of the DTD file and this file must have been taken into consideration during development of any automated procedures for subsequent processing of the received information. Thus there will typically be a considerable delay between carrying out subroutine S100 and performance of remaining steps S10-S50.

At step S10, a computer wishing to communicate some information to a receiving computer generates an XML file containing the information to be transmitted. This can be done in any number of well known manners including simply using a text editor application to generate a text file.

At step S20 an XML processor application is employed to attempt to validate the XML file generated in step S20 in respect of the DTD file generated in subroutine S100. If the XML file is not successfully validated, the user has an option to attempt to edit the XML file in an attempt to make the file conform to the required structure. Alternatively, it may be that the nature of the information is such that in order to communicate the information successfully a new DTD file has to be generated. In this case the user may terminate the procedure and recommence it at subroutine S100. If, however, validation is performed successfully, then the method proceeds to step S30.

In step S30 the generated and validated XML file is transmitted as a text file to the receiving computer. This may be done in an indirect manner by, for example, transmitting the file firstly to a server computer and then downloading the file from the server computer to the receiving computer.

In step S40 the receiving computer uses the DTD file (which may have been received directly from the transmitting computer, or it could have been generated locally using the subroutine S100 with the same or an equivalent set of example XML files, or by some other method or means) to again attempt to validate the received XML file. In the event that the XML file is not successfully validated by the XML processor using the DTD file, the process is terminated. Optionally, the receiving computer may automatically request the transmitting computer to re-send the file since it is possible that the file was corrupted during transmission. Alternatively, the receiving computer might simply alert a user to the fact that the received file has not been successfully validated and enable the user to decide what further action should be taken.

However, in the event that the received file is successfully validated in step S40, then the method proceeds to step S50 in which the XML file is further processed automatically by the receiving computer without requiring any user intervention. The method ends upon completion of step S50.

Referring now to FIG. 4, the way in which subroutine S100 operates to generate a DTD file according to the present invention will now be described in overview.

Subroutine S100 commences at step S110 in which an example XML file (which the DTD file to be generated is supposed to be able to validate) is input to the process.

At step S120 the input XML file is parsed using a conventional XML to Document Object Model (DOM) tree parsing application (it will be appreciated that there are a large number of publicly available applications which perform this function) to generate a DOM tree representation of the input XML file.

At step S130 it is determined if there are more example XML files to be used in generating the DTD file. If so, the method returns to step S110 and steps S110 and S120 are repeated for each additional example XML file to be used in generating the DTD file. Once all of the example XML files have been converted into corresponding DOM trees the subroutine S100 proceeds to step S40.

In step S140 the or each DOM tree generated previously is processed in a manner described in greater detail below to generate an intermediate structure (which is also described in greater detail below).

In step S50 the intermediate structure generated in step S140 is processed to generate a DTD file in a manner described in greater detail below.

Finally, in step S160 the DTD file generated in step S150 is output, as the final output of the subroutine, to whichever process (or thread) called the subroutine; upon completion of step S160 the subroutine ends.

How the Intermediate Structure is Built

During DOM tree traversal, when an Element node is met, provided that it is not already in the linked list, a new reference to the node is formed in the linked list. The references to nodes are constructed by referring to the Nodes from the structure of the DOM tree, so that it is possible to traverse the DOM tree directly from a reference to a node in the linked list. This list (or in actual fact list of lists) groups together the Elements that have the same Element node name into individual lists. Any repeated Element (ie having the same name, the same children elements and the same attributes) is discarded. Below, the algorithm for this intermediate structure building is described using pseudo-code.

```
ISBuilder(Node n) {
  If (n is an element type)
    If (a reference to n is not in the list)
    Add(reference to n to the list)
    For all n's children n₁ to nₘ do
    ISBuilder(nᵢ) where (1 ≦ i ≦ m)
}
```

The Intermediate Structure

As mentioned above, having parsed an XML file the parser returns a DOM tree structure (see below). This is an n-ary tree that can be walked to generate DTD/Schema code for the XML file. What this embodiment performs is creation of an Intermediate Structure (IS), the role of which is to group together DOM tree nodes in a way that:

a) the task of code generation becomes much easier, as the IS bundles the related nodes into a sub-structure of their own

b) by maintaining a single IS that can serve several XML files, a single DTD/Schema file may easily be generated which encompasses the union of all their features.

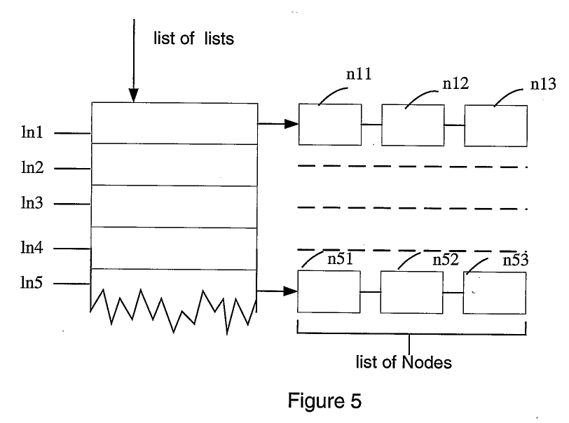

Referring now to FIG. 5, during the course of walking the DOM tree, whenever a node of an element type is encountered, if the node n11, n51 (in actual fact for efficiency purposes a pointer or reference to the actual node in the relevant DOM tree) does not exist in the IS, a new common list of nodes ln1-ln5 is added to the IS and the new node is added to the respective new list. However, if an element node n12, n13, n52, n53 of the same name but with a differing attribute list or child list is encountered, this element node is kept in the same list ln1-ln5 as the first encountered node of that name. If a node is encountered with the same name and the same child list and attribute list as a previously encountered node, no record is kept of the newly encountered node and the procedure passes on to the next node.

DOM Tree

As mentioned above, a DOM parser takes an XML file as input and generates a corresponding DOM tree. In Java each node of the tree is an element of a type which implements the interface referred to in Java as Node. Consider the following XML document:

```
<books>
  <book name=”Hamlet”>
    <author>
      William Shakespeare
    </author>
  </book>
  <book name=”Ulysses”>
    <author>
      James Joyce
    </author>
  </book>
</books>
```

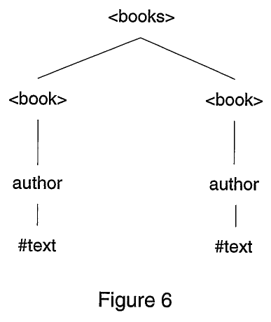

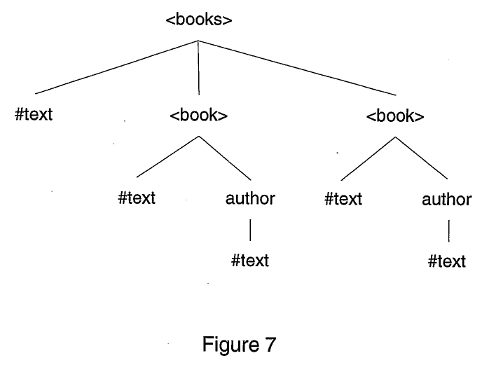

This XML file after parsing by an XML to DOM tree parser results in a tree structure which can be visually represented as in FIG. 6. However, since XML documents are text based, any text, including the texts that are put there for indentation and readability (i.e. blank space) are returned by some simple XML to DOM tree parsers as a child of some Node, as #text (see FIG. 7). To generate a DTD/Schema file which correctly validates the XML file these “#text”s, which represent blank spaces only, need to be pruned. The pseudo-code below presents the algorithm to prune the DOM tree for this purpose employed in the present embodiment.

```
removeWhiteTextNode(Node n) {
  For all n's children n₁ to nₘ do
  If (n is a text type AND it is white space) {
    remove(nᵢ) where (1 ≦ i ≦ m)
    removeWhiteTextNode(n)
  }
  For all n's children n₁ to nₘ do
  removeWhiteTextNode (nᵢ) where (1 ≦ i ≦ m)
}
```

As should be clear, what this algorithm does is to go down the DOM tree depth-first-left-to-right and prune the #text. The reason for recalling the method after removing a detected blank space is to traverse the tree a second time to prevent only the first encountered #text being pruned. This is generally unnecessary as the blank space will generally be a leaf node.

Modularising Schema Design Development

One of the more powerful by-products of generating an Intermediate Structure (IS) is that since the code generation phase of system is delayed to post IS phase, it is possible to use and expand the building of the IS across several XML/DOM tree structures to one super-IS which will generate a single DTD/schema file which serves all those XML files (providing they have the same root Element). This enables the XML designer to
a) modularise the XML/schema design by designing the different parts of XML/schema file separately; and
b) concentrate on the concrete cases rather than some vague abstract.
   An Example of Modularised Design and Development

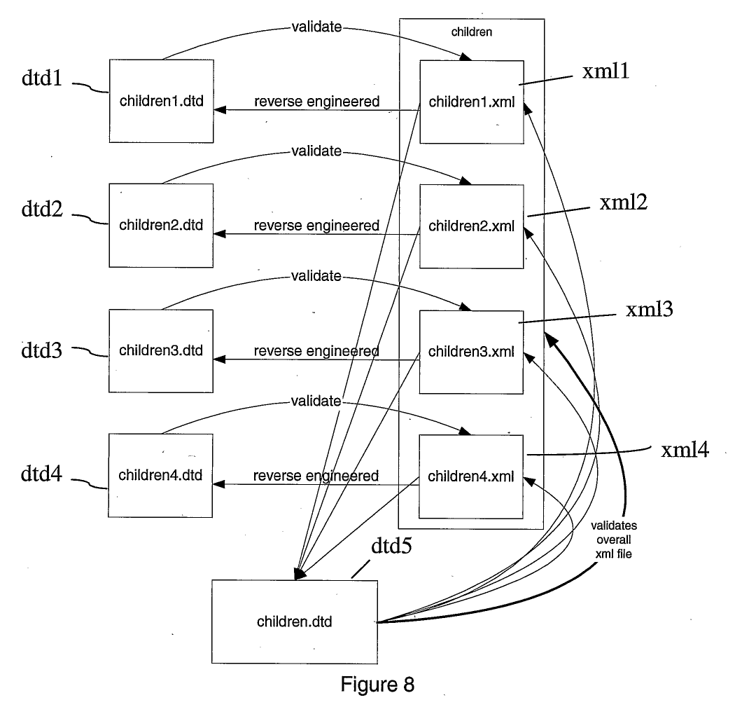

Consider the following example in which the aim is to design a DTD/Schema for an XML document that has various components. In this example ‘children’ has four components i.e. boy and its variations and girl. See below the four XML documents xml1-xml4 (see FIG. 8):

| | |
|---|---|
| <?xml version=“1.0”?> | <?xml version=“1.0”?> |
| <!DOCTYPE children SYSTEM | <!DOCTYPE children SYSTEM |
| “children1.dtd”> | “children1.dtd”> |
| <children> | <children> |
| <boy name=“Danny”> | <girl name=“Clare”> |
| <school schoolName=“St John”/> | <school schoolName=“St Jude”/> |
| <grade> excellent </grade> | <grade> Mediocre </grade> |
| <record father=“Andrei” | <record father=“Dennis” |
| mother=“Arabella” age=“7”/> | mother=“Maggie” age=“8”/> |
| </boy> | </girl> |
| </children> | </children> |
| <?xml version=“1.0”?> | <?xml version=“1.0”?> |
| <!DOCTYPE children SYSTEM | <!DOCTYPE children SYSTEM |
| “children1.dtd”> | “children1.dtd”> |
| <children> | <children> |
| <boy name=“Joey”> | <boy name=“Alex”> |
| <playgroup playgroupName=“St | <school schoolName=“Latimer”/> |
| Andrew”/> | <grade> OK </grade> |
| <grade> excellent </grade> | <record father=“John” mother=“Julia” |
| <record father=“Andrei” | age=“4”/> |
| mother=“Arabella” age=“4”/> | <toy> Rabbit </toy> |
| </boy> | </boy> |
| </children> | </children> |

The corresponding four DTD files dtd1-dtd4 are given below:

| | |
|---|---|
| <!ELEMENT children (boy)> | <!ELEMENT children (girl)> |
| <!ELEMENT boy (school, grade, record)> | <!ELEMENT girl (school, grade,record)> |
| <!ELEMENT school EMPTY> | <!ELEMENT school EMPTY> |
| <!ELEMENT grade (#PCDATA)> | <!ELEMENT grade (#PCDATA)> |
| <!ELEMENT record EMPTY> | <!ELEMENT record EMPTY> |
| <!ATTLIST boy | <!ATTLIST girl |
| name CDATA #REQUIRED | name CDATA #REQUIRED |
| > | > |
| <!ATTLIST school | <!ATTLIST school |
| schoolName CDATA #REQUIRED | schoolName CDATA #REQUIRED |
| > | > |
| <!ATTLIST record | <!ATTLIST record |
| father CDATA #REQUIRED | father CDATA #REQUIRED |
| mother CDATA #REQUIRED | mother CDATA #REQUIRED |
| age CDATA #REQUIRED | age CDATA #REQUIRED |
| > | > |
| <!ELEMENT children (boy)> | <!ELEMENT children (boy)> |
| <!ELEMENT boy (playgroup, grade, | <!ELEMENT boy (school, grade, record, toy)> |
| record)> | <!ELEMENT school EMPTY> |
| <!ELEMENT playgroup EMPTY> | <!ELEMENT grade (#PCDATA)> |
| <!ELEMENT grade (#PCDATA)> | <!ELEMENT record EMPTY> |
| <!ELEMENT record EMPTY> | <!ELEMENT toy (#PCDATA)> |
| <!ATTLIST boy | <!ATTLIST boy |
| name CDATA #REQUIRED | name CDATA #REQUIRED |
| > | > |
| <!ATTLIST playgroup | <!ATTLIST school |
| playgroupName CDATA #REQUIRED | schoolName CDATA #REQUIRED |
| > | > |
| <!ATTLIST record | <!ATTLIST record |
| father CDATA #REQUIRED | father CDATA #REQUIRED |
| mother CDATA #REQUIRED | mother CDATA #REQUIRED |
| age CDATA #REQUIRED | age CDATA #REQUIRED |
| > | > |

However, if they are input simultaneously to the method of the present embodiment the following DTD file dtd5 results:

```
<!ELEMENT children ((boy) | (girl))>
<!ELEMENT boy ((playGroup, grade, record) | (playgroup, grade,
record) | (school, grade, record, toy))>
<!ELEMENT playGroup EMPTY>
<!ELEMENT grade (#PCDATA)>
<!ELEMENT record EMPTY>
<!ELEMENT girl (school, grade, record)>
<!ELEMENT school EMPTY>
<!ELEMENT playgroup EMPTY>
<!ELEMENT toy (#PCDATA)>
<!ATTLIST boy
  name CDATA #REQUIRED
>
<!ATTLIST playGroup
  playgroupName CDATA #REQUIRED
>
<!ATTLIST record
  father CDATA #REQUIRED
  mother CDATA #REQUIRED
  age CDATA #REQUIRED
>
<!ATTLIST girl
  name CDATA #REQUIRED
>
<!ATTLIST school
  schoolName CDATA #REQUIRED
>
<!ATTLIST playgroup
  playgroupName CDATA #REQUIRED
>
```

The FIG. 8 schematically presents how each of the individual dtd files dtd1-dtd4 can only validate its own single corresponding xml file xml1-xml4 respectively, but the general dtd file dtd5 generated by inputting all four xml files xml1-xml4 simultaneously to the method of the present embodiment is able to validate all four xml files xml1-xml4.

Generation of DTD file from Intermediate Structure

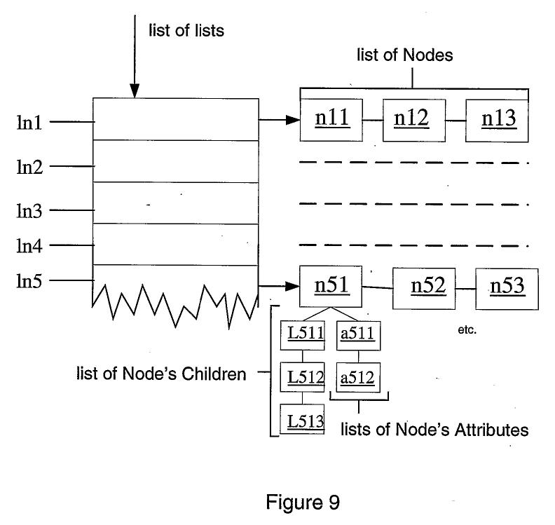

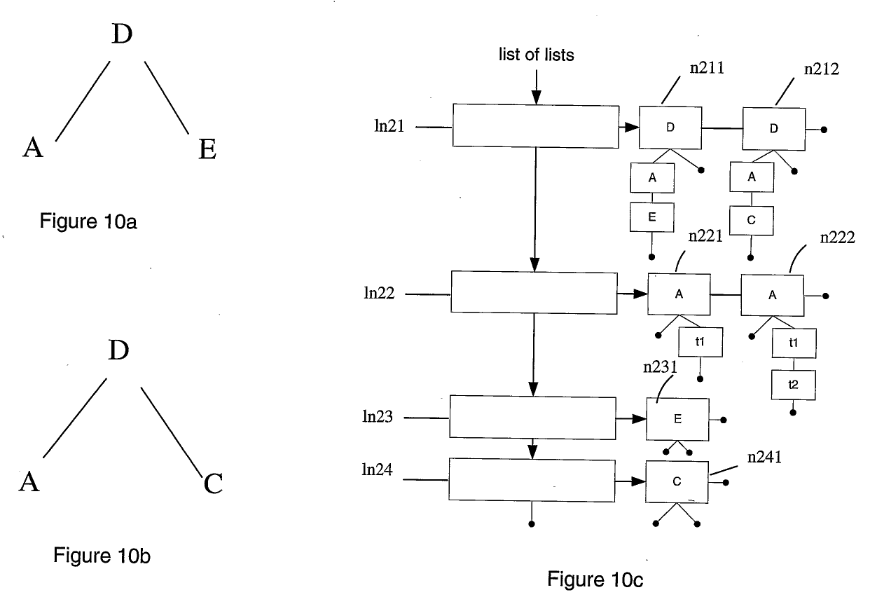

FIG. 9 is similar to FIG. 5 but additionally shows the internal structure of node n51, from which it can be seen that it includes a list of children c511, c512, c513 and attributes a511, a512. The manner in which the Intermediate structure is generated from a DOM tree is described below with reference to FIG. 10. Before that, however, it is explained how in the present embodiment, a DTD file is generated from an Intermediate Structure.

To generate the DTD, we have to traverse the Intermediate Structure using the algorithm set out below in pseudo-code. The structure is traversed twice, once to capture and set out the syntax of the elements (i.e. the ELEMENT's) and then a second time for the syntax of the attributes (i.e. the ATTLIST's). Though it might be more efficient to deal with both aspects in one pass (as is envisaged for alternative embodiments of the present invention), for clarity and ease of understanding the two parts have been separated in the present embodiment.

Pseudo-Code

| DTDgenerator( ) { | |
|---|---|
| for (i = 0; i < size of listOfList; i = i+1) { | |
| let currentElm be the ith elment of listoflist | |
| let len be the size of currentElm | |
| write(″<!ELEMENT ″) | |
| write(the currentElm's Name) | // all the nodes in |
| | //currentElm have same name |

```
    write(″(″)
    initialise the childLst empty
    for (j = 0; j < len; j = j+1) {
      let aNode be the jth cell of ith element of the listoflist
      let childLst be the list of the children of the aNode
      write (childLst in a comma separated fashion)
      if (j < len−1)
        write(″ | ″)
      clear the childLst
    }
    write(″)″)
    write(″>” + newLineCharacter)
  }
  attribSection( )
}
```

To generate the ELEMENT section of the DTD file basically what the above algorithm does is to walk the list-of-lists. Each element of the second level list is a Node. For each Node, the algorithm outputs the list of children as a comma separated list, within brackets. Between each of these bracketed lists the algorithm places the or symbol i.e. (“|”). For example, the example described below with reference to FIG. 10 produces:

<!ELEMENT D ((A, E)|(A, C))>

The Pseudo Code for attribSection Plus Two Auxiliary Methods (getCurrrentAttribLst and sortAttribute)

```
getCurrentAttribLst(alist) {
  for (int i = 0; i < size of aList; i = i+1) {
    let aNode be the ith element of aList
  for (int k = 0; k < size of aNode's attributes list; k = k+1)
    if (attribList does not contains the kth element of the aNode)
      add the kth element of the node to the attribList, also,
      make its status REQUIRED
                // initiate all attributes REQUIRED
  }
}
  sortAttribute(aList) {
    let attribList be the Attribute List
    getCurrentAttribLst(aList) //in this method, attribList gets populated
    Node aNode
    for (j = 0; j < size of aList; j = j+1) {
      for (i = 0; i < size of attribList; i = i+1) {
        if (the status of ith element of attribList is equal REQUIRED) {
          let aNode be the jth element of the aList
          if (the ith element's name in attribList is not in the list
          of attributes' of aNode)
            set the ith element of the attribList. as IMPLIED
        }
      }
    }
  }
  attribSection( ) {
    for (i = 0; i < size of listOfList; i = i+1) {
      let aList be the ith elment of listoflist
      sortAttibute(aList)
      aNode = (Node)(aList.get(0))
      if (attribList has any element) { // if the list is not empty
        write(“<!ATTLIST ” + aNode.getNodeName( ) +
        newLineCharacter)
        let p = 0
        for (; p < size of attribList − 1; p = p+1) {
          write(“ ” + name of the pth element of attribList)
          write(“ CDATA ” + attribute of the pth element of the
          attribList + newLineCharacter)
        }
        write(“ ” + name of the pth element of attribList)
        write(“ CDATA ” + attribute of the pth element of the
attribList + newLineCharacter + “>” + newLineCharacter)
        write(newLineCharacter)
      }
    }
  }
```

From the above pseudo-code (note that the symbol “+” when used in “write” statements above represents concatenation of the elements on either side of the “+” symbol in the manner in which this is done in the Java programming language), it can be seen that the algorithm for determining whether an attribute is required or implied involves:
for each element of the list-of-lists (which will be a list of nodes) every node is traversed and all of the attributes under each node are collected and inserted into a new list, attribList (one per list-of-list), with each attribute originally marked as REQUIRED;
then the attribute list of each node is traversed again, checking that each REQUIRED attribute in attribList is present, if an attribute in attribList is not present in a particular attribute list of a node, that attribute is re-marked in attribList as IMPLIED;
finally the resulting attribList is used to generate the ATTLIST statement for that element.
   An Example of How The Algorithm Works

Consider the following very simple XML files:

| | |
|---|---|
| <?xml version=“1.0”?> | <?xml version=“1.0”?> |
| <!DOCTYPE D SYSTEM | <!DOCTYPE D SYSTEM |
| “AA1.dtd”> | “AA1.dtd”> |
| <D> | <D> |
| <A t1=“x”/> | <A t1=“x” t2=“y”/> |
| <E/> | <C/> |
| </D> | </D> |

The pruned DOM trees generated from these files are shown schematically in FIGS. 10a and 10b respectively. Note that node A of FIG. 10a differs from node A of FIG. 10b in that the latter has attributes t1 and t2 whereas node A in FIG. 10a has attribute t1 only, although this distinction is not shown in FIGS. 10a and 10b. The Intermediate Structure generated from these two DOM trees is illustrated in FIG. 10c. It is arrived at by first parsing the DOM tree of FIG. 10a and encountering firstly node D with children nodes A and E but no attributes and creating a new list ln21 and storing therein a reference n211 to node D in the DOM tree of FIG. 10a. It then creates a new list ln22 for the A node and stores a reference n221 to node A of the DOM tree of FIG. 10a. The method then causes a list ln23 to be created and stores therein a reference n231 to the node E of the DOM tree of FIG. 10a.

The method then proceeds to traverse the DOM tree of FIG. 10b. On encountering node D of the DOM tree of FIG. 10b it determines that it already has a list ln21 created for storing references to D nodes; it determines that the D node of FIG. 10b does not have the same children and attributes as the D node of FIG. 10a (note although the attributes are the same since neither has any the child lists are different as one has children A and E whereas the other has children A and C) and therefore stores a new reference n212 to the node D of the DOM tree of FIG. 10b. It then encounters node A of the DOM tree of FIG. 10b, determines that it differs from node A of the DOM tree of FIG. 10a (because it has different attributes) and therefore stores a new reference n222 in list ln22 to the node A of the DOM tree of FIG. 10b. Finally, the method encounters node C of the DOM tree of FIG. 10b, notes that no list yet exists for such nodes and therefore creates a new list ln24 and stores therein a reference n241 to the node C of the DOM tree of FIG. 10b.

Having created the Intermediate Structure of FIG. 10c in this manner, the algorithm operates in the manner described above to generate the following DTD file:

```
<!ELEMENT D ((A, E) | (A, C))>
<!ELEMENT A EMPTY>
<!ELEMENT E EMPTY>
<!ELEMENT C EMPTY>
<!ATTLIST A
  t1 CDATA #REQUIRED
  t2 CDATA #IMPLIED
>
```

Mathematical Notion

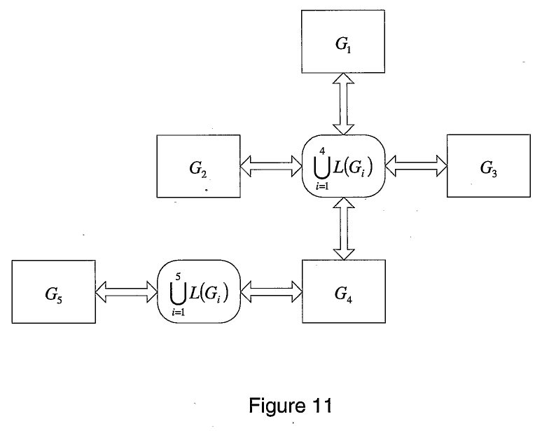

Referring now to FIG. 11, by introducing some mathematical notation to refer to XML files and DTD files (or XML schema files) respectively, it is possible to demonstrate concisely how a system whereby different entities may efficiently communicate information between one another may be provided using the method of the above described embodiment.

Therefore, consider letting G be an XML file and D be the DTD/schema generated by reverse engineering G according to the method of the above described embodiment. Let L(G) be the set of all XML files which can be validated by D.

Now, Let {G, G₂, . . . , Gₙ} be a set of XML files and Δ(Dₙ) be the corresponding DTD file generated by the reverse engineering process that pulls all the XML files together. The

$${⋃}_{i = 1}^{n} L ( {G}_{i} )$$

is the set of all XML files that can be validated by Δ(Dₙ).
A Scenario

In a distributed environment processes which are responsible for each XML file Gᵢ ε {G₁, G₂, . . . , Gₙ} can be scattered logically and physically at various places. For example consider, in a B2B setting, four enterprises getting together to form a consortium of a sort. They exchange data among themselves using XML files to co-ordinate this arrangement and to make sure that data sent by one partner is understood by the other partner(s) in their(s) internal processes. To this end they can exchange their XML sampler files which capture all the features of their requirements to other members of the group and each will arrive at their own copy of the DTD file Δ(D₄) (all identical). The Δ(D₄) can be used to validate all XML files that are process-able by other parties (i.e. ∀(G) Where G is an XML file and

$$G ∈ {⋃}_{i = 1}^{4} L ( {G}_{i} ) ) .$$

Notice that, in this distributed setting there is no central processor which co-ordinates the inter-enterprise activities. Though activities are coordinated through shared data format, nonetheless, they are purely peer-to-peer at the point of interaction. Now, assume the fourth enterprise, (G₄), for some reason needs to communicate with another enterprise (G₅); this relationship could be a transient arrangement which does not involve a direct interaction between the fifth enterprise (G₅) and the other three (G₁, G₂, G₃). However, the data format needs to be organised or arranged in such a way that the fourth enterprise can use it in its interactions with the other three original participants. To this end, all that is needed is for the fourth enterprise and its new associate to organise their data by adding the G₅ of the new enterprise with {G₁, G₂, G₃, G₄}, and then generating the DTD/schema Δ(D₅). The XML files that can be validated by this Δ(D₅) are

$${⋃}_{i = 1}^{5} L ( {G}_{i} ) .$$

Now since

$${⋃}_{i = 1}^{4} L ( {G}_{i} ) ⊆ {⋃}_{i = 1}^{5} L ( {G}_{i} ) , \{ \begin{matrix}{G}_{1} , & {G}_{2} , & {G}_{3} , & {G}_{4}\end{matrix} \}$$

can be validated by Δ(D₅). What we have demonstrated here is that this system of combining DTD schema validation from multiple files will suit a distributed environment where participants can dynamically be altered by expansion or contraction. In particular, it should be noted that each party simply needs to obtain example xml files from all of the parties with which it needs to communicate in order to ensure that it can communicate fully, and thus there is no need for any centralised control, so that the whole process can be achieved in a completely distributed manner.
Further Example

This further example presents two files which fundamentally have the same structure, though in appearance are different. This difference in appearance is even more pronounced because the XML file contains a recursive structure.

```
<?xml version=“1.0”?>
<!DOCTYPE exp SYSTEM “expression.dtd”>
<!-- (x+y) -->
<exp>
  <para>
    <exp>
      <op>
        <plus>
          <exp>
            <id value=“x”/>
          </exp>
          <exp>
            <id value=“y”/>
          </exp>
        </plus>
      </op>
    </exp>
  </para>
</exp>
?xml version=“1.0”?>
<!DOCTYPE exp SYSTEM “expression.dtd”>
<!-- ((x + y) + (w + z)) -->
<exp>
  <para>
    <exp>
      <op>
        <plus>
          <exp>
            <para>
              <exp>
                <op>
                  <plus>
                    <exp>
                      <id value=“x”/>
                    </exp>
                    <exp>
                      <id value=“y”/>
                    </exp>
                  </plus>
                </op>
              </exp>
            </para>
          </exp>
          <exp>
            <para>
              <exp>
                <op>
                  <plus>
                    <exp>
                      <id value=“w”/>
                    </exp>
                    <exp>
                      <id value=“z”/>
                    </exp>
                  </plus>
                </op>
              </exp>
            </para>
          </exp>
        </plus>
      </op>
    </exp>
  </para>
</exp>
```

These two XML files although structurally identical are in appearance different. The embodiment described above however generates identical DTD files:

<!ELEMENT exp ((para) | (op) | (id))>
<!ELEMENT para (exp)>
<!ELEMENT op (plus)>
<!ELEMENT plus (exp, exp)>
<!ELEMENT id EMPTY>
<!ATTLIST id
value CDATA #REQUIRED
>

1. A method of transmitting information between first and second electronic devices, the method including generating a validator file operable to validate or to not validate eXtensible Markup Language, XML, files according to their structure, transmitting to the second device the validator file itself or information to enable the validator file to be acquired by the second device, generating an XML file which contains the information to be transmitted structured in such a way that it is validatable by the generated validator file, transmitting the XML file to the second device and validating the XML file received by the second device, wherein the validator file is generated by:
acquiring and parsing an example XML file, the XML file having a structure which the validator file to be generated should cause to be validated, to generate a tree structured file comprising a root node and one or more subsidiary nodes each of which corresponds to an element within the example XML file and has an associated child and attribute list which contain the names of zero or more children nodes and zero or more attributes respectively;
acquiring and parsing any additional example XML files to generate corresponding additional tree structured files;
traversing the or each tree structured file to generate an intermediate structure comprising groups of nodes in which, each time a node is encountered which does not have the same name as any previously encountered node, a new group is created in the intermediate structure and one or more details of the node in question are stored in the group, and each time a node is encountered which does have the same name as any previously encountered node its child and attribute lists are compared with those of the or each previously encountered node having the same name and if there is a match, no further entry is made in the group, but if there is a mismatch, then a new entry comprising one or more details of the node is made within the same group as the previously encountered node of the same name; and
generating the validator file based upon the intermediate structure.

2. A method according to claim 1 wherein the or each tree structure is a Document Object Model (DOM) tree.

3. A method according to claim 1 wherein the validator file is a Document Type Definition, DTD, file or an XML schema definition file.

4. A method according to claim 1 wherein the intermediate structure and the groups forming the intermediate structure are Java objects, and wherein the details of a node stored in a group are a reference to a Java object representing the node in one of the one or more tree structured files.

5. A method according to claim 1 further including the step of the second device automatically processing the received XML file upon successful validation by the validator file.

6. A method of generating a validator file operable to validate or to not validate extensible Markup Language, XML, files according to their structure, comprising:
acquiring and parsing an example XML file, the XML file having a structure which the validator file to be generated should cause to be validated, to generate a tree structured file comprising a root node and one or more subsidiary nodes each of which corresponds to an element within the example XML file;
acquiring and parsing any additional example XML files to generate corresponding additional tree structured files;
traversing the or each tree structured file to generate an intermediate structure comprising groups of nodes in which, each time a node is encountered which does not have the same name as any previously encountered node, a new group is created in the intermediate structure and one or more details of the node in question are stored in the group, and each time a node is encountered which does have the same name as any previously encountered node its child and attribute lists are compared with those of the or each previously encountered node having the same name and if there is a match, no further entry is made in the group, but if there is a mismatch, then a new entry comprising one or more details of the node is made within the same group as the previously encountered node of the same name; and
generating the validator file based upon the intermediate structure.

7. A method of communicating information between two or more devices within a distributed environment, the method comprising:
each device receiving example XML files from each other device with which it is to share information representative of the data which each other party intends to send to the respective device;
utilising these received XML files, in combination with one or more XML files representative of the data which the respective device intends to send to the other parties, to generate a validator file which is operable to validate all of the utilised XML files; and
using the validator files to validate any received or transmitted XML files communicated between the devices.

8. A method according to claim 7 in which information is communicated between three or more devices.

9. A system for transmitting information between first and second computers, the system including the first and second computers together with a computer network connecting the computers together, wherein the first computer is operable to generate a validator file operable to validate or to not validate eXtensible Markup Language, XML, files according to their structure, to transmit to the second computer the validator file itself or information to enable the validator file to be acquired by the second computer, and to generate an XML file which contains the information to be transmitted structured in such a way that the XML file is validatable by the generated validator file, and wherein the first computer includes means for transmitting the XML file to the second computer over the computer network and wherein the second computer includes means for validating the XML file upon receipt using the validator file, wherein the first computer includes means for generating the validator file by:
acquiring and parsing an example XML file, the XML file having a structure which the validator file to be generated should cause to be validated, to generate a tree structured file comprising a root node and one or more subsidiary nodes each of which corresponds to an element within the example XML file and has an associated child and attribute list which contain the names of zero or more children nodes and zero or more attributes respectively;
acquiring and parsing any additional example XML files to generate corresponding additional tree structured files;
traversing the or each tree structured file to generate an intermediate structure comprising groups of nodes in which, each time a node is encountered which does not have the same name as any previously encountered node, a new group is created in the intermediate structure and one or more details of the node in question are stored in the group, and each time a node is encountered which does have the same name as any previously encountered node its child and attribute lists are compared with those of the or each previously encountered node having the same name and if there is a match, no further entry is made in the group, but if there is a mismatch, then a new entry comprising one or more details of the node is made within the same group as the previously encountered node of the same name; and
generating the validator file based upon the intermediate structure.

10. A system for transmitting information between first and second computers, the system including the first and second computers together with a computer network connecting the computers together, wherein the first computer is operable to generate a validator file operable to validate or to not validate eXtensible Markup Language, XML, files according to their structure, to transmit to the second computer the validator file itself or information to enable the validator file to be acquired by the second computer, and to generate an XML file which contains the information to be transmitted structured in such a way that the XML file is validatable by the generated validator file, and wherein the first computer is further operable to transmit the XML file to the second computer over the computer network and wherein the second computer is operable to validate the XML file upon receipt using the validator file, wherein the first computer is operable to generate the validator file by:
acquiring and parsing an example XML file, the XML file having a structure which the validator file to be generated should cause to be validated, to generate a tree structured file comprising a root node and one or more subsidiary nodes each of which corresponds to an element within the example XML file and has an associated child and attribute list which contain the names of zero or more children nodes and zero or more attributes respectively;
acquiring and parsing any additional example XML files to generate corresponding additional tree structured files;
traversing the or each tree structured file to generate an intermediate structure comprising groups of nodes in which, each time a node is encountered which does not have the same name as any previously encountered node, a new group is created in the intermediate structure and one or more details of the node in question are stored in the group, and each time a node is encountered which does have the same name as any previously encountered node its child and attribute lists are compared with those of the or each previously encountered node having the same name and if there is a match, no further entry is made in the group, but if there is a mismatch, then a new entry comprising one or more details of the node is made within the same group as the previously encountered node of the same name; and
generating the validator file based upon the intermediate structure.

11. A computer program or suite of computer programs for causing a computer or computers to carry out the method or method steps of any of claim 1 during execution.

12. A carrier medium carrying the computer program or programs of claim 11.
